(19) United States
(12) Patent Application Publication
(10) Pub. No.: US 2026/0246050 A1
(43) Pub. Date: Aug. 20, 2026

(54) VEHICULAR BATTERY CASE AND METHOD FOR MANUFACTURING SAME

(71) Applicant: Kabushiki Kaisha Kobe Seiko Sho (Kobe Steel, Ltd.), Kobe-shi (JP)

(72) Inventors: Sadao MIYAZAWA, Kobe-shi (JP); Kenichi WATANABE, Kobe-shi (JP); Artur REKETS, Kobe-shi (JP)

(73) Assignee: Kabushiki Kaisha Kobe Seiko Sho (Kobe Steel, Ltd.), Kobe-shi (JP)

(21) Appl. No.: 19/164,242

(22) PCT Filed: Feb. 22, 2024
(86) PCT No.: PCT/JP2024/006559

§ 371 Date: Sep. 11, 2025

(30) Foreign Application Priority Data
Mar. 28, 2023 (JP) 2023-052043

(51) Int. Cl. H01M 50/242; H01M 50/249; H01M 50/271

(52) U.S. Cl. CPC H01M 50/242; H01M 50/249; H01M 50/271; H01M 2220/20

(57) ABSTRACT

A vehicular battery case 100 includes an upper cover 120 which is a tray-shaped press-formed product functioning as a lid, has a housing portion 121 for housing a battery 10, and is provided with an upper surface projecting portion 123 extending in a vehicle width direction from a left end to a right end and projecting upward on an upper surface 122 of the housing portion 121, an under cover 150 that closes the upper cover 120 from below to house the battery 10, and an upper surface outer lateral reinforcing member 110 arranged on the upper cover 120 and extending in the vehicle width direction from a left end to a right end of the housing portion 121.

### TECHNICAL FIELD

The present disclosure relates to a vehicular battery case and a method for manufacturing the vehicular battery case.

### BACKGROUND ART

In a vehicle equipped with a large capacity battery such as an electric vehicle, a battery is stored in a battery case and arranged on the lower side of a vehicle interior.

Such a vehicular battery case is required to have high sealing performance for preventing ingress of water from a road surface and high battery protection performance at the time of vehicle collision.

Patent Documents 1 to 3 disclose a vehicular battery case in which a battery is stored in a tray-shaped case to secure high sealing performance, and high battery protection performance is secured by a shape of a tray and a reinforcing member.

### PRIOR ART DOCUMENT

### Patent Documents

Patent Document 1: JP 2021-41783 A

Patent Document 2: JP 2021-64448 A

Patent Document 3: JP 2020-111101 A

### SUMMARY OF THE INVENTION

### Problems to Be Solved by the Invention

In the vehicular battery case of Patent Documents 1 to 3, a tray-shaped case stores a battery, and is closed from above by a substantially flat upper cover. That is, a lid body functions merely as a lid, and does not significantly contribute to battery protection performance.

An object of the present disclosure is to ensure high battery protection performance by using an upper cover in a vehicular battery case and a method for manufacturing the vehicular battery case.

### Solutions to the Problems

A first aspect of the present disclosure provides a vehicular battery case including an upper cover which is a tray-shaped press-formed product functioning as a lid, has a housing portion for housing a battery, and is provided with an upper surface projecting portion extending in a vehicle width direction from a left end to a right end and projecting upward on an upper surface of the housing portion, an under cover that closes the upper cover from below to house the battery, and an upper surface outer lateral reinforcing member arranged on the upper cover and extending in the vehicle width direction from a left end to a right end of the housing portion.

According to this configuration, a load transmission path can be provided in the vehicle width direction by the upper surface projecting portion, and high battery protection performance against an impact in the vehicle width direction can be secured with a simple structure. Specifically, by providing the upper surface projecting portion, load capacity can be improved as compared with a simple flat plate, and a larger load can be transmitted. Further, since the upper cover as a press-formed product formed by: press-molding a single metal plate does not have a seam such as a joint portion, it is possible to prevent ingress of water from the outside and to secure high sealing performance.

The upper cover and the upper surface outer lateral reinforcing member may be joined to each other.

According to this configuration, since the under cover and the upper surface outer lateral reinforcing member can integrally receive a load, higher battery protection performance against an impact in the vehicle width direction can be secured.

At least one of the upper cover and the upper surface outer lateral reinforcing member may constitute a floor panel serving as a vehicle interior floor surface.

According to this configuration, it is not necessary to provide a floor panel as a separate body, and the number of components can be reduced and weight can be reduced.

The vehicular battery case may further include an upper surface inner lateral reinforcing member that extends in the vehicle width direction from a left end to a right end of the housing portion along the upper surface projecting portion and is arranged in the upper cover so as to be at least partially housed in the upper surface projecting portion.

According to this configuration, since a load can also be received by the upper surface inner lateral reinforcing member, higher battery protection performance against an impact in the vehicle width direction can be secured.

A material of the upper cover may be a steel material having a tensile strength of 590 MPa or more.

According to this configuration, higher battery protection performance can be secured by the upper cover made from a high-strength steel material.

The configuration may be such that only a central portion in a vehicle front-rear direction of the upper cover has a tailor welded blank structure.

According to these configurations, strength of the central portion in the vehicle front-rear direction of the upper cover can be increased as compared with other portions. For example, by the tailor welded blank structure, it is possible to employ a high-strength material or increase thickness of the central portion. The central portion is a portion to which a high load is applied in a side collision of an automobile, and high load capacity is required. For this reason, it is effective to increase the strength of the central portion.

The battery may be suspended from the upper cover and arranged so as to be spaced apart from the under cover.

According to this configuration, even in a case where a load is applied to the under cover, the load is not directly transmitted from the under cover to the battery, so that higher battery protection performance can be secured.

The vehicular battery case may further include a lower surface longitudinal reinforcing member arranged below the under cover, extending in the vehicle front-rear direction, and joined to the under cover.

According to this configuration, since the under cover and the lower surface longitudinal reinforcing member can integrally receive a load, high battery protection performance against an impact in the vehicle front-rear direction can be secured.

A second aspect of the present disclosure provides a method for manufacturing a vehicular battery case, the method including preparing an upper cover which is a tray-shaped press-formed product functioning as a lid, has a housing portion for housing the battery, and is provided with an upper surface projecting portion extending in a vehicle width direction from a left end to a right end and projecting upward on an upper surface of the housing portion, an under cover that closes the upper cover from below to house the battery, an upper surface outer lateral reinforcing member arranged on the upper cover in a manner extending in the vehicle width direction from a left end to a right end of the housing portion, a battery mount that is installed on the under cover and receives the battery, and a side sill that extends in a vehicle front-rear direction on an outer side in the vehicle width direction of the upper cover, attaching an upper portion of the battery to a base member, placing the battery attached to the base member on the battery mount, fastening the under cover and the side sill from below, and suspending the battery from the upper cover and arranging the battery in a manner spaced apart from the battery mount by fastening the base member, the upper cover, and the upper surface outer lateral reinforcing member.

According to this manufacturing method, high battery protection performance can be secured using the upper cover as described above. Further, even in a case where a load is applied to the under cover as described above, the load is not directly transmitted from the under cover to the battery, so that higher battery protection performance can be secured.

### Effects of the Invention

According to the present disclosure, in a vehicular battery case and a method for attaching the vehicular battery case, high battery protection performance can be secured using an upper cover.

### BRIEF DESCRIPTION OF THE DRAWINGS

FIG. 1 is a side view of a vehicle.

FIG. 2 is a perspective view of a vehicular battery case according to a first embodiment of the present invention.

FIG. 3 is an exploded perspective view of the vehicular battery case of FIG. 2.

FIG. 4 is a perspective view showing an upper cover, an upper surface outer lateral reinforcing member, and an upper surface inner lateral reinforcing member.

FIG. 5 is a cross-sectional view of the vehicular battery case taken along line V-V of FIG. 2.

FIG. 6 is a perspective view of a vehicle body lower structure on which the vehicular battery case of FIG. 2 is mounted.

FIG. 7 is a perspective view of the upper cover in the vehicular battery case according to a second embodiment of the present invention.

### DETAILED DESCRIPTION

Hereinafter, an embodiment of the present invention will be described with reference to the accompanying drawings.

### First Embodiment

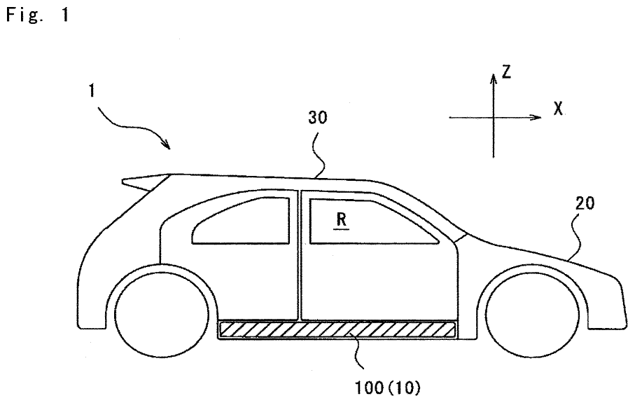

Referring to FIG. 1, an automobile 1 travels by driving a motor with electric power supplied from a battery 10. For example, the automobile 1 may be an electrically powered vehicle such as an electric vehicle or a plug-in hybrid vehicle. A type of the automobile 1 is not particularly limited, and may be a passenger vehicle, a truck, a work vehicle, another type of mobility, or the like. Hereinafter, a case of an electric vehicle of a normal passenger vehicle type as the automobile 1 will be described as an example.

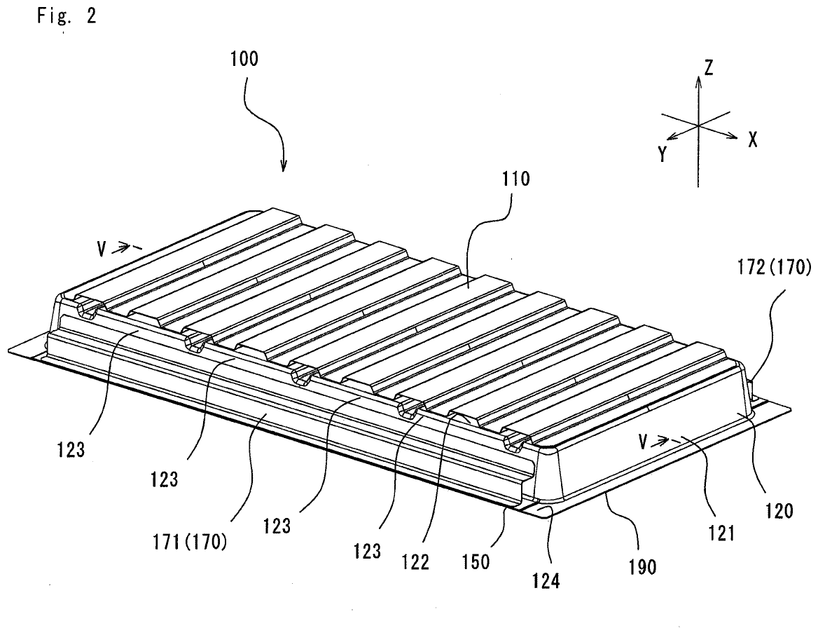

In the automobile 1, a motor, a high-voltage device, and the like are mounted on a vehicle body front portion 20. Further, the automobile 1 is mounted with a vehicular battery case 100 (hereinafter, also simply referred to as the battery case 100) in which a battery 10 serving as a driving power source is stored in substantially the entire lower surface of a vehicle interior R of a vehicle body central portion 30. In FIG. 1, a vehicle front-rear direction of the automobile 1 is indicated by an X direction (an arrow indicates a forward direction), and a vehicle vertical direction is indicated by a Z direction (an arrow indicates an upward direction). The same notation is used in subsequent drawings, and a vehicle width direction of the automobile 1 is indicated by a Y direction (an arrow indicates a right direction) in FIG. 2 and subsequent drawings.

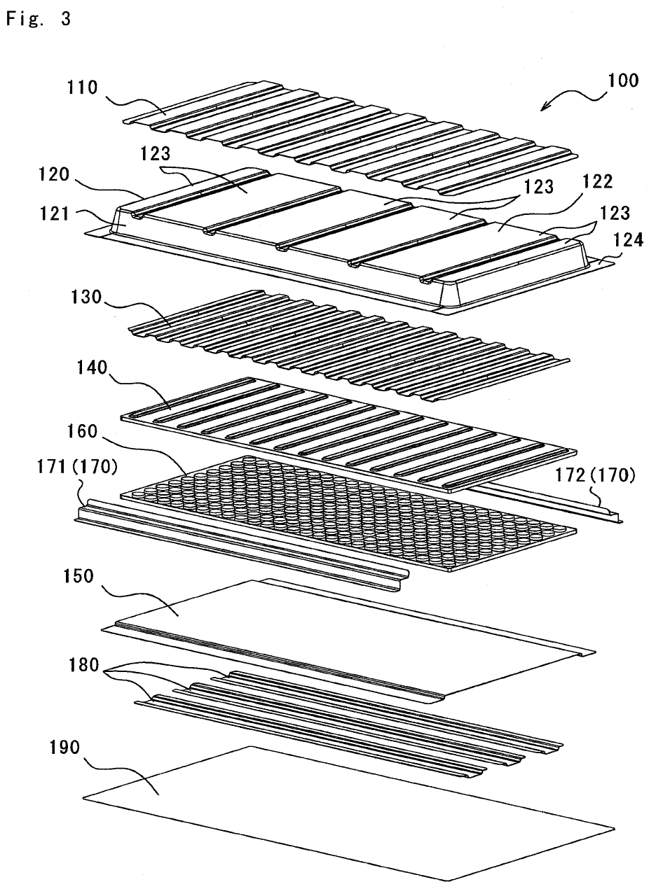

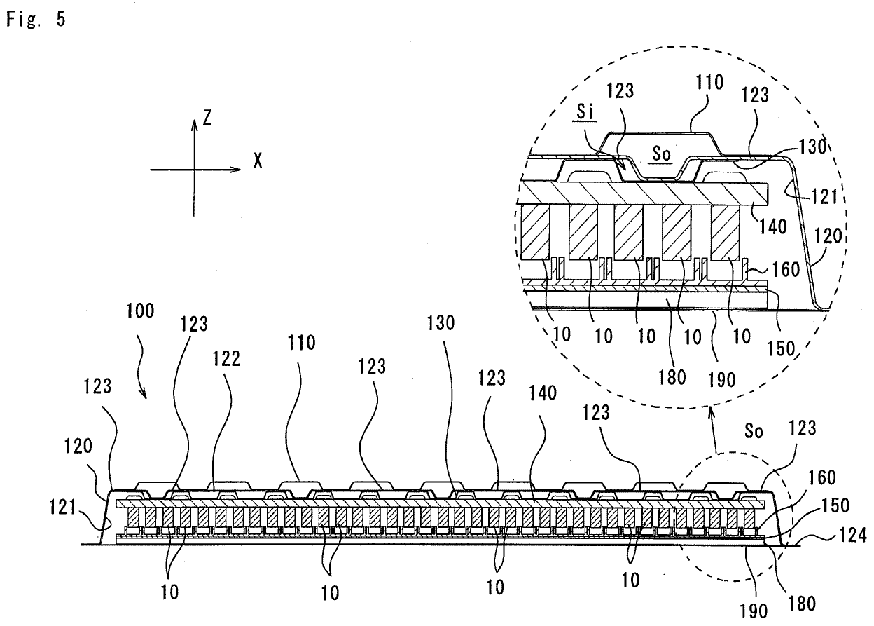

Referring to FIGS. 2 to 5, the battery case 100 of the present embodiment includes an upper surface outer lateral reinforcing member 110, an upper cover 120, an upper surface inner lateral reinforcing member 130, a base member 140, an under cover 150, a battery mount 160, a frame 170, a lower surface longitudinal reinforcing member 180, and a bottom plate 190. In FIG. 3, illustration of the battery 10 is omitted, and in FIG. 5, the battery 10 is illustrated. The batteries 10 have a columnar shape elongated in the vehicle vertical direction, and are densely arranged side by side in the vehicle front-rear direction and the vehicle width direction. In FIG. 5, a portion surrounded by a broken line circle is enlarged.

The upper cover 120 is a tray-shaped member functioning as a lid, and is formed by press-molding one metal plate. That is, the upper cover 120 is a press-formed product of a single member having no seam such as a joint portion. The upper cover 120 has a housing portion 121 for housing the battery 10, and an upper surface projecting portion 123 extending in the vehicle width direction from a left end to a right end and projecting upward is provided on an upper surface 122 of the housing portion 121. The number of the upper surface projecting portions 123 may be one or more than one. A flange portion 124 extends outward in a horizontal direction from a lower end of the housing portion 121.

The upper cover 120 is made from, for example, a steel material. Specifically, a material of the upper cover 120 may be a steel material having a tensile strength of 590 MPa or more. High battery protection performance can be secured by the upper cover 120 made from a steel material having high strength. Further, a material of the upper cover 120 may be another metal material such as an aluminum alloy.

The upper surface outer lateral reinforcing member 110 is a member that reinforces the upper cover 120. In the present embodiment, the upper surface outer lateral reinforcing member 110 is a corrugated plate having a hat shape continuous in a cross section perpendicular to the vehicle width direction. The upper surface outer lateral reinforcing member 110 is arranged on the upper cover 120 (outside the upper cover 120), and extends in the vehicle width direction from a left end to a right end of the housing portion 121 of the upper cover 120. The upper surface outer lateral reinforcing member 110 has a rectangular shape having substantially the same size as the housing portion 121 of the upper cover 120 when viewed from the vehicle vertical direction. However, a shape, size or the number of the upper surface outer lateral reinforcing members 110 may be arbitrarily set.

The upper surface outer lateral reinforcing member 110 is joined to the upper cover 120, and forms a plurality of outer reinforcing spaces So with the upper cover 120 (see FIG. 5). That is, when viewed from the vehicle width direction, the upper surface outer lateral reinforcing member 110 forms a plurality of closed cross-sectional shapes defining a plurality of the outer reinforcing spaces So together with the upper cover 120. This improves load capacity in the vehicle width direction.

The upper surface outer lateral reinforcing member 110 is made from, for example, a steel material. Specifically, a material of the upper surface outer lateral reinforcing member 110 may be a steel material having a tensile strength of 980 to 1470 MPa or more. Further, a material of the upper surface outer lateral reinforcing member 110 may be another metal material such as an aluminum alloy.

The upper surface inner lateral reinforcing member 130 is a member that reinforces the upper cover 120. In the present embodiment, the upper surface inner lateral reinforcing member 130 is a corrugated plate having a hat shape continuous in a cross section perpendicular to the vehicle width direction. The upper surface inner lateral reinforcing member 130 is arranged below the upper cover 120 (inside the upper cover 120) so as to be at least partially housed in the upper surface projecting portion 123, and extends in the vehicle width direction from a left end to a right end of the housing portion 121 along the upper surface projecting portion 123 of the upper cover 120. Further, the upper surface inner lateral reinforcing member 130 has a rectangular shape having substantially the same size as the housing portion 121 of the upper cover 120 when viewed from the vehicle vertical direction. However, a shape, size or the number of the upper surface outer lateral reinforcing members 110 may be arbitrarily set.

The upper surface inner lateral reinforcing member 130 is joined to the upper cover 120 and forms a plurality of closed inner reinforcing spaces Si with the upper cover 120 (see FIG. 5). That is, when viewed from the vehicle width direction, the upper surface inner lateral reinforcing member 130 forms a plurality of closed cross-sectional shapes defining a plurality of the inner reinforcing spaces Si together with the upper cover 120. This improves load capacity in the vehicle width direction.

The upper surface inner lateral reinforcing member 130 is made from, for example, a steel material. Specifically, a material of the upper surface inner lateral reinforcing member 130 may be a steel material having a tensile strength of 980 to 1470 MPa or more. Further, a material of the upper surface inner lateral reinforcing member 130 may be another metal material such as an aluminum alloy. Note that the upper surface inner lateral reinforcing member 130 may be omitted as necessary.

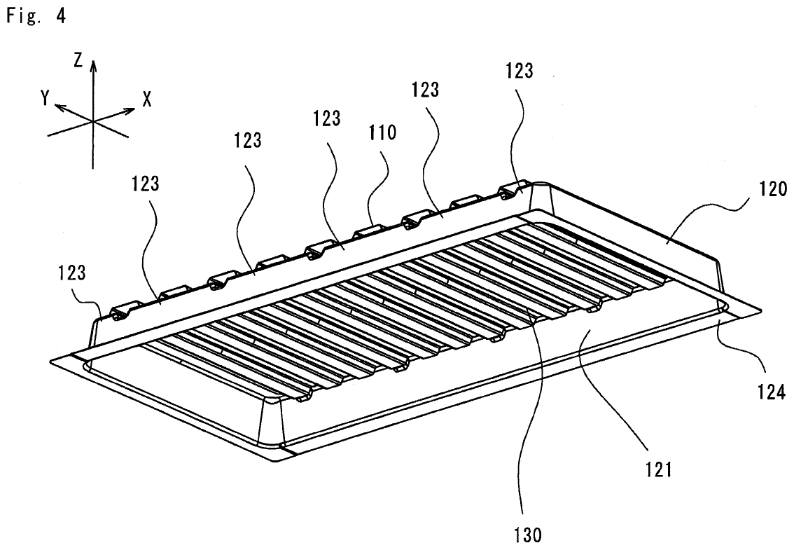

The base member 140 is a member that holds the battery 10 in a suspended manner. In the example of FIG. 5, a plurality of the batteries 10 having a cylindrical shape are arranged so as to be suspended from the base member 140. The base member 140 has a substantially rectangular shape as viewed in the vehicle vertical direction, and has a shape complementary to the upper surface inner lateral reinforcing member 130 as viewed in the vehicle width direction. The base member 140 is joined to a lower surface of the upper surface inner lateral reinforcing member 130, and is located at an upper portion in the housing portion 121 (see FIG. 4).

The under cover 150 closes the upper cover 120 from below (at least partially) to house the battery 10. In the present embodiment, the under cover 150 has a substantially flat plate shape in which both outer sides in the vehicle width direction of the housing portion 121 are stepped down.

The under cover 150 is made from, for example, a steel material. Specifically, a material of the under cover 150 may be a steel material having a tensile strength of 590 MPa or more. By this, high battery protection performance can be secured by the under cover 150 made from a high-strength steel material. Further, a material of the under cover 150 may be another metal material such as an aluminum alloy.

The battery mount 160 is a component that is installed on (on an upper surface of) the under cover 150 and temporarily receives the battery 10 in a process of manufacturing the battery case 100. The battery mount 160 has a plurality of bottomed cylindrical shapes complementary to a plurality of the batteries 10, and a plurality of the batteries 10 are mounted and have their positions in the horizontal direction fixed.

Note that in a state of a completed product of the battery case 100, as described above, a plurality of the batteries 10 are arranged so as to be suspended from the base member 140, and thus are not placed on the battery mount 160. Note that the battery mount 160 may be omitted as necessary.

The frame 170 is arranged on the outside in the vehicle width direction of the upper cover 120. In the present embodiment, the frame 170 includes side frames 171 and 172 extending over the entire length of the upper cover 120 in the vehicle front-rear direction. However, the frame 170 is not limited to this form, and may be arranged over the entire outer periphery of the upper cover 120 when viewed from the vehicle vertical direction, for example.

The side frames 171 and 172 are formed by bending a steel plate, for example. Specifically, a material of the side frames 171 and 172 may be a steel material having a tensile strength of 980 to 1470 MPa or more. Further, a material of these may be another metal material such as an aluminum alloy. Note that the frame 170 may be omitted as necessary.

The lower surface longitudinal reinforcing member 180 is a member that reinforces the under cover 150. The lower surface longitudinal reinforcing member 180 is arranged below the under cover 150, extends in the vehicle front-rear direction from a front end to a rear end of the housing portion 121, and is joined to the under cover 150. In the illustrated example, three of the lower surface longitudinal reinforcing members 180 having a hat-shaped cross section are provided.

The lower surface longitudinal reinforcing member 180 is made from, for example, a steel material. Specifically, a material of the lower surface longitudinal reinforcing member 180 may be a steel material having a tensile strength of 980 to 1470 MPa or more. Further, a material of the lower surface longitudinal reinforcing member 180 may be another metal material such as an aluminum alloy. Note that the lower surface longitudinal reinforcing member 180 may be omitted as necessary.

The bottom plate 190 is a metal plate arranged below the under cover 150 and the lower surface longitudinal reinforcing member 180. The bottom plate 190 has a rectangular shape having substantially the same size as the upper cover 120 when viewed from the vehicle vertical direction. The bottom plate 190 is joined to the flange portion 124 of the upper cover 120. In the present embodiment, the bottom plate 190 is a flat steel plate. For example, the bottom plate 190 is a 1.4 mm steel plate. However, the thickness and material of the bottom plate 190 are not particularly limited, and may be appropriately set. Note that the bottom plate 190 may be omitted as necessary.

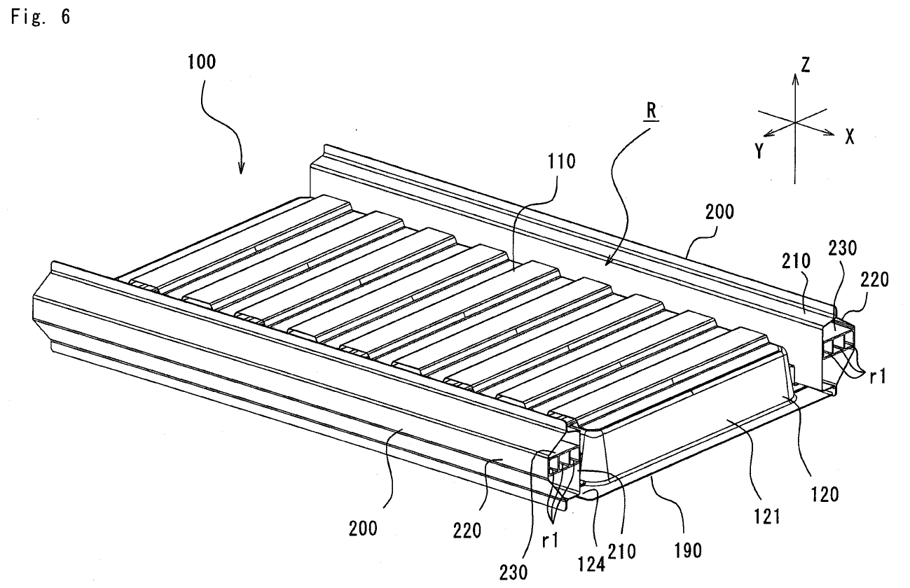

Referring to FIG. 6, the battery case 100 having the above configuration constitutes a part of a vehicle body lower structure of the automobile 1 as described below.

Side sills 200 are arranged on both outer sides in the vehicle width direction of the battery case 100. The side sill 200 is a member that extends in the vehicle front-rear direction and constitutes an outer surface in the vehicle width direction of the automobile 1. The side sill 200 is configured such that an inner panel 210 and an outer panel 220, which are metal plates, are bonded to each other, and a buffer member 230 is arranged in a space between the inner panel 210 and the outer panel 220. The buffer member 230 has a plurality of rooms r1 arranged in the vehicle width direction, and has a function of buffering an impact from a side surface of the automobile 1.

In the present embodiment, the upper surface outer lateral reinforcing member 110 constitutes a floor panel serving as a floor surface of the vehicle interior R. That is, the upper surface outer lateral reinforcing member 110 has a function of reinforcing the upper cover 120 and a function as a floor panel. Note that in a case where the upper surface outer lateral reinforcing member 110 is not arranged so as to cover the entire upper surface 122 of the upper cover 120, at least one of the upper surface outer lateral reinforcing member 110 and the upper cover 120 constitutes a floor panel.

Next, a method for manufacturing the battery case 100 of the present embodiment will be described.

First, the above-described components are prepared (see FIGS. 3 and 6). Next, an upper portions of the battery 10 is attached to the base member 140. After the above, the battery 10 attached to the base member 140 is placed on the battery mount 160. Then, the under cover 150 on which the battery 10 is placed via the battery mount 160, the frame 170, and the side sill 200 are fastened (for example, fastened with a bolt and a nut) from below. After the above, the base member 140, the upper cover 120, the upper surface outer lateral reinforcing member 110, and the upper surface inner lateral reinforcing member 130 are fastened (for example, fastened together by bolt-nut fastening), so that the battery 10 is suspended from the upper cover 120 and arranged so as to be spaced apart from the battery mount 160 (see FIG. 5). Note that, as described above, the frame 170 and the upper surface inner lateral reinforcing member 130 may be omitted as necessary.

The vehicular battery case 100 according to the present embodiment has a function and an effect below.

A load transmission path can be provided in the vehicle width direction by the upper surface projecting portion 123 of the upper cover 120, and high battery protection performance against an impact in the vehicle width direction can be secured with a simple structure. Specifically, by providing the upper surface projecting portion 123, load capacity can be improved as compared with a simple flat plate, and a larger load can be transmitted. Further, since the upper cover 120 as a press-formed product formed by press-molding a single metal plate does not have a seam such as a joint portion, it is possible to prevent ingress of water from the outside and to secure high sealing performance.

Further, since the upper cover 120 and the upper surface outer lateral reinforcing member 110 are joined to each other, the upper cover 120 and the upper surface outer lateral reinforcing member 110 can integrally receive a load. For this reason, higher battery protection performance against an impact in the vehicle width direction can be secured.

Further, since at least one of the upper cover 120 and the upper surface outer lateral reinforcing member 110 functions as a floor panel, it is not necessary to provide a floor panel as a separate body, and the number of components can be reduced and weight can be reduced.

Further, since a load can also be received by the upper surface inner lateral reinforcing member 130, higher battery protection performance against an impact in the vehicle width direction can be secured.

Further, since the battery 10 is arranged so as to be spaced apart from the under cover 150, even in a case where a load is applied to the under cover 150, the load is not directly transmitted from the under cover 150 to the battery 10, so that higher battery protection performance can be secured.

Further, since the under cover 150 and the lower surface longitudinal reinforcing member 180 are joined to each other, the under cover 150 and the lower surface longitudinal reinforcing member 180 can integrally receive a load. For this reason, high battery protection performance against an impact in the vehicle front-rear direction can be secured.

### Second Embodiment

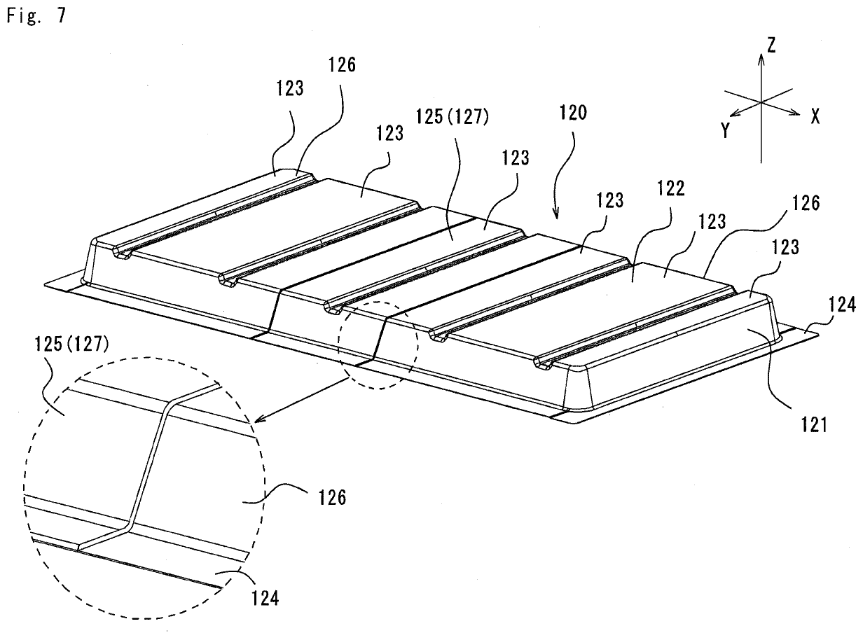

A vehicular battery case of a second embodiment shown in FIG. 7 is different from that of the first embodiment in a shape of an upper cover 120. The second embodiment is substantially the same as the first embodiment except for a portion related to the above. Therefore, the description of a portion illustrated in the first embodiment may be omitted. In FIG. 7, only the upper cover 120 is illustrated, and a portion surrounded by a broken line circle is illustrated in an enlarged manner.

In the present embodiment, only a central portion 125 in the vehicle front-rear direction of the upper cover 120 has a tailor welded blank structure. In the tailor welded blank structure, a plate material is stacked on a specific portion by using press working. In the illustrated example, as the central portion 125, the tailor welded blank structure is provided in a region of about ¼ from the center in the vehicle front-rear direction. The central portion 125 in the vehicle front-rear direction may be, for example, a region to about the half from the center in the vehicle front-rear direction. Here, a region in front of or behind the central portion 125 in the vehicle front-rear direction is referred to as an outer portion 126.

In the illustrated example of the tailor welded blank structure, another metal plate 127 is stacked at the central portion 125, and a thickness of the central portion 125 is made larger than a thickness of the outer portion 126. That is, only the central portion 125 is formed of two metal plates. For example, in a case where the upper cover 120 is made from a steel material, a steel plate having a higher tensile strength may be stacked and arranged at the central portion 125.

According to the present embodiment, a strength of the central portion 125 in the vehicle front-rear direction of the upper cover 120 can be increased as compared with other portions. The central portion 125 is a portion to which a high load is applied in a side collision of an automobile, and high load capacity is required. For this reason, it is effective to increase the strength of the central portion 125.

Although a specific embodiment of the present invention and a variation of the embodiment are described above, the present invention is not limited to the above embodiment, and various modifications can be made within the scope of the present invention. For example, an embodiment of the present invention may be obtained by appropriately combining content of individual embodiments.

The present disclosure may include an aspect below.

### First Aspect

A vehicular battery case including:
an upper cover which is a tray-shaped press-formed product functioning as a lid, has a housing portion for housing a battery, and is provided with an upper surface projecting portion extending in a vehicle width direction from a left end to a right end and projecting upward on an upper surface of the housing portion;
an under cover that closes the upper cover from below to house the battery; and
an upper surface outer lateral reinforcing member arranged on the upper cover and extending in the vehicle width direction from a left end to a right end of the housing portion.

### Second Aspect

The vehicular battery case according to the first aspect, in which the upper cover and the upper surface outer lateral reinforcing member are joined to each other.

### Third Aspect

The vehicular battery case according to the first or second aspect, in which at least one of the upper cover and the upper surface outer lateral reinforcing member constitutes a floor panel serving as a vehicle interior floor surface.

### Fourth Aspect

The vehicular battery case according to any of the first to third aspects, further including an upper surface inner lateral reinforcing member that extends in a vehicle width direction from a left end to a right end of the housing portion along the upper surface projecting portion and is arranged in the upper cover so as to be at least partially housed in the upper surface projecting portion.

### Fifth Aspect

The vehicular battery case according to any of the first to fourth aspects, in which a material of the upper cover is a steel material having a tensile strength of 590 MPa or more.

### Sixth Aspect

The vehicular battery case according to any of the first to fifth aspects, in which only a central portion in a vehicle front-rear direction of the upper cover has a tailor welded blank structure.

### Seventh Aspect

The vehicular battery case using the case according to any of the first to sixth aspects, in which the battery is suspended from the upper cover and arranged so as to be spaced apart from the under cover.

### Eighth Aspect

The vehicular battery case according to any of the first to seventh aspects, further including a lower surface longitudinal reinforcing member arranged below the under cover, extending in a vehicle front-rear direction, and joined to the under cover.

### Ninth Aspect

A method for manufacturing a vehicular battery case, the method including:
preparing an upper cover which is a tray-shaped press-formed product functioning as a lid, has a housing portion for housing a battery, and is provided with an upper surface projecting portion extending in a vehicle width direction from a left end to a right end and projecting upward on an upper surface of the housing portion, an under cover that closes the upper cover from below to house the battery, an upper surface outer lateral reinforcing member arranged on the upper cover in a manner extending in the vehicle width direction from a left end to a right end of the housing portion, a battery mount that is installed on the under cover and receives the battery, and a side sill that extends in a vehicle front-rear direction on an outer side in the vehicle width direction of the upper cover;
attaching an upper portion of the battery to a base member;
placing the battery attached to the base member on the battery mount;
fastening the under cover and the side sill from below; and
suspending the battery from the upper cover and arranging the battery in a manner spaced apart from the battery mount by fastening the base member, the upper cover, and the upper surface outer lateral reinforcing member.

This application claims priority based on Japanese Patent Application No. 2023-052043 filed on Mar. 28, 2023. Japanese Patent Application No. 2023-052043 is incorporated herein by reference.

### REFERENCE SIGNS LIST

1 automobile
10 battery
20 vehicle body front portion
30 vehicle body central portion
100 battery case (vehicular battery case)
110 upper surface outer lateral reinforcing member
120 upper cover
121 housing portion
122 upper surface
123 upper surface projecting portion
124 flange portion
125 central portion
126 outer portion
127 metal plate
130 upper surface inner lateral reinforcing member
140 base member
150 under cover
160 battery mount
170 frame
171,172 side frame
180 lower surface longitudinal reinforcing member
190 bottom plate
200 side sill
210 inner panel
220 outer panel
230 buffer member

1. A vehicular battery case comprising:
an upper cover which is a tray-shaped press-formed product functioning as a lid, has a housing portion for housing a battery, and is provided with an upper surface projecting portion extending in a vehicle width direction from a left end to a right end and projecting upward on an upper surface of the housing portion;
an under cover that closes the upper cover from below to house the battery; and
an upper surface outer lateral reinforcing member arranged on the upper cover and extending in the vehicle width direction from a left end to a right end of the housing portion.

2. The vehicular battery case according to claim 1, wherein the upper cover and the upper surface outer lateral reinforcing member are joined to each other.

3. The vehicular battery case according to claim 1, wherein at least one of the upper cover and the upper surface outer lateral reinforcing member constitutes a floor panel serving as a vehicle interior floor surface.

4. The vehicular battery case according to claim 1, further comprising an upper surface inner lateral reinforcing member that extends in a vehicle width direction from a left end to a right end of the housing portion along the upper surface projecting portion and is arranged in the upper cover so as to be at least partially housed in the upper surface projecting portion.

5. The vehicular battery case according to claim 1, wherein a material of the upper cover is a steel material having a tensile strength of 590 MPa or more.

6. The vehicular battery case according to claim 1, wherein only a central portion in a vehicle front-rear direction of the upper cover has a tailor welded blank structure.

7. The vehicular battery case according to claim 1, wherein the battery is suspended from the upper cover and arranged so as to be spaced apart from the under cover.

8. The vehicular battery case according to claim 1, further comprising a lower surface longitudinal reinforcing member arranged below the under cover, extending in a vehicle front-rear direction, and joined to the under cover.

9. A method for manufacturing a vehicular battery case, the method comprising:
preparing an upper cover which is a tray-shaped press-formed product functioning as a lid, has a housing portion for housing a battery, and is provided with an upper surface projecting portion extending in a vehicle width direction from a left end to a right end and projecting upward on an upper surface of the housing portion, an under cover that closes the upper cover from below to house the battery, an upper surface outer lateral reinforcing member arranged on the upper cover in a manner extending in the vehicle width direction from a left end to a right end of the housing portion, a battery mount that is installed on the under cover and receives the battery, and a side sill that extends in a vehicle front-rear direction on an outer side in the vehicle width direction of the upper cover;
attaching an upper portion of the battery to a base member;
placing the battery attached to the base member on the battery mount;
fastening the under cover and the side sill from below; and
suspending the battery from the upper cover and arranging the battery in a manner spaced apart from the battery mount by fastening the base member, the upper cover, and the upper surface outer lateral reinforcing member.
